(19) United States
(12) Patent Application Publication
(10) Pub. No.: US 2011/0202939 A1
(43) Pub. Date: Aug. 18, 2011

(54) OPTICAL DISC DEVICE AND RECORDING AND REPRODUCING METHOD

(76) Inventor: Takuya HIMI, Tokyo (JP)

(21) Appl. No.: 13/014,272

(22) Filed: Jan. 26, 2011

(30) Foreign Application Priority Data
Feb. 16, 2010 (JP) 2010-031178

(51) Int. Cl. G11B 7/135

(52) U.S. Cl. 720/681; G9B/7.112

(57) ABSTRACT

There is provided an optical disc device for reproducing or recording an optical disc. The optical disc device includes an object lens configured to irradiate the optical disc with light emitted from a light source; an actuator for controlling tilt of the object lens in a radial direction of the optical disc at a tilt value; a temperature sensor for detecting a temperature inside the optical disc device; and a controller for correcting the tilt value in accordance with a change in the temperature from the temperature detected at an initial adjustment of the optical disc device which is performed in loading of the optical disc.

### CLAIM OF PRIORITY

The present application claims priority from Japanese patent application JP 2010-31178 filed on Feb. 16, 2010, the content of which is hereby incorporated by reference into this application.

### BACKGROUND OF THE INVENTION

This invention relates to an optical disc device and a recording and reproducing method. In particular, this invention relates to tilt control (inclination control) of an object lens in the optical disc device.

When an optical disc is inclined from a direction perpendicular to an optical axis of laser light emitted from an optical pickup, information cannot be properly recorded to or reproduced from the optical disc. Hence, tilt (inclination) control of an object lens is usually performed in the optical pickup.

As conventional arts, JP2007-305264A discloses adjustment of a tilt (tilt angle) at an initial adjustment (a setup) in loading an optical disc; JP2005-216331A discloses learning of an optimum tilt value with respect to temperature in view of the amount of reflection in recording to an optical disc; and JP04-307431A discloses control of track offset and focus offset for a tilt of an optical disc caused by a change in temperature to take indirect measures against the tilt of the optical disc.

### SUMMARY OF THE INVENTION

However, even if the tilt has been adjusted at a setup like in JP2007-305264A, the temperature may change thereafter to require correction of the tilt. Conducting the tilt learning and control according to JP2005-216331A at every change in temperature to follow the change may interrupt recording or reproducing of an optical disc at the learning. The control disclosed in JP04-307431A is a two dimensional control in which individual offsets are added to or deducted from a tracking control signal and a focus control signal, so that an error in reproducing or recording might be large.

In view of the above circumstances, conventional arts might not be able to correct the tilt appropriately for a change in temperature after a setup.

An object of this invention is to correct the tilt properly for a change in temperature after an initial adjustment (a setup).

A representative aspect of this invention is as follows. That is, there is provided an optical disc device for reproducing or recording an optical disc, comprising: an object lens configured to irradiate the optical disc with light emitted from a light source; an actuator for controlling tilt of the object lens in a radial direction of the optical disc at a tilt value; a temperature sensor for detecting a temperature inside the optical disc device; and a controller for correcting the tilt value in accordance with a change in the temperature from the temperature detected at an initial adjustment of the optical disc device which is performed in loading of the optical disc.

According to an aspect of this invention, proper correction of the tilt of the object lens is achieved for a change in temperature after an initial adjustment.

### BRIEF DESCRIPTION OF THE DRAWINGS

The present invention can be appreciated by the description which follows in conjunction with the following figures, wherein:

FIG. 1 is a block diagram illustrating a configuration of an optical disc device in the first embodiment of this invention;

FIG. 2 is a diagram exemplifying deformation of an optical disc because of change in temperature;

FIG. 3 is a diagram exemplifying relationships between temperature and tilt values of an object lens;

FIG. 4 is a diagram illustrating a method of obtaining a tilt value from symbol error rate;

FIG. 5 is a flowchart of tilt control in the first embodiment;

FIG. 6 is a diagram exemplifying a reference table for determining a factor of proportionality depending on the type of optical disc in the first embodiment; and

FIG. 7 is a diagram exemplifying a reference table for determining a tilt correction value (an absolute value) depending on the type of optical disc in the second embodiment.

### DETAILED DESCRIPTION OF THE EMBODIMENTS

### First Embodiment

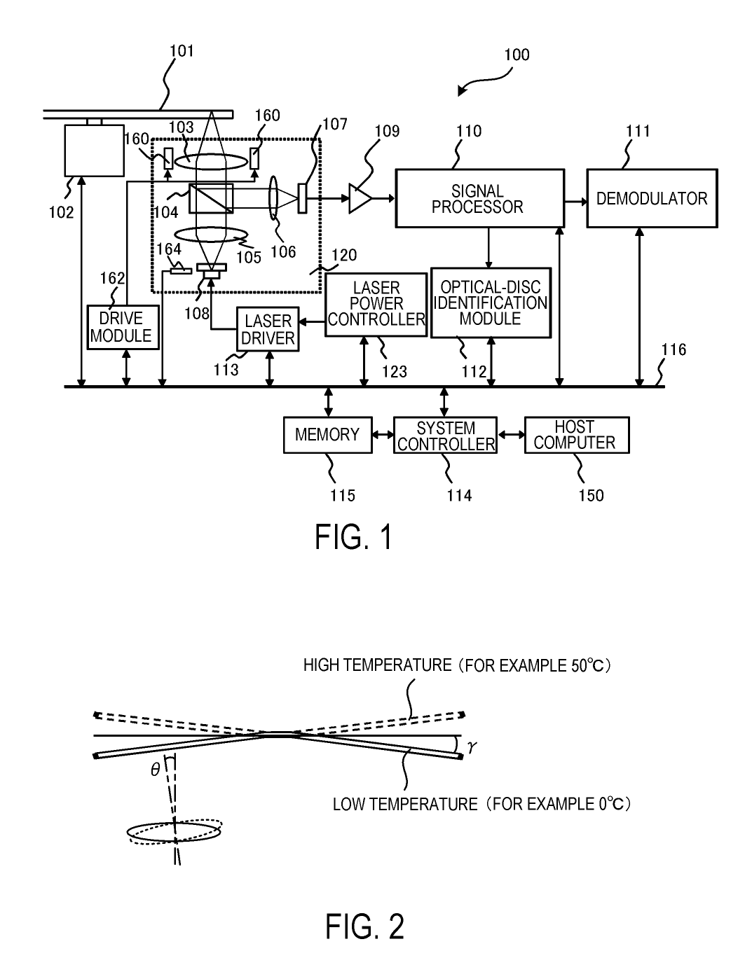

FIG. 1 is a block diagram illustrating a configuration of an optical disc recording and reproducing apparatus (hereinafter, referred to as an optical disc device) 100 in preferred embodiments.

The optical disc device 100 in this embodiment is connected to a host computer 150 and outputs data read from an optical disc 101 (for example, a Blu-ray Disc) loaded therein to the host computer 150. The optical disc device 100 may have a function of recording data received from the host computer 150 onto a writable optical disc 101.

The optical disc device 100 in this embodiment comprises a spindle motor 102, a current-to-voltage (I/V) converter 109, a signal processor 110, a demodulator 111, an optical-disc identification module 112, a laser driver 113, a system controller (control unit) 114, a memory 115, a data bus 116, an optical pickup 120, and a laser power controller 123.

The spindle motor 102 rotates and drives an optical disc 101 loaded in the optical disc device 100.

The optical pickup 120 comprises an object lens 103, a beam splitter 104, a collimating lens 105, a focal lens 106, a photoelectric converter 107, a laser light source 108. When reading data in an optical disc 101, the optical pickup 120 irradiates the optical disc 101 with weak laser light, reproduces data recorded on the optical disc 101 using the reflection of the laser light, and outputs an RF (radio frequency) signal corresponding to the reflection.

The laser light source 108 is a semiconductor laser that generates a desired intensity of laser light for reading and writing, and emits laser light having a wavelength specified for each type of loaded disc, such as CD (Compact Disc), DVD (Digital Versatile Disc), and BD (Blue-ray Disc). The laser light emitted by the laser light source 108 impinges on a specific radial position of the recording surface of the optical disc 101 through the collimating lens 105 and the object lens 103.

In writing data onto the optical disc 101, the laser light source 108 irradiates the optical disc 101 with more intensive laser light than in reading data therefrom. By thermal phase-change at the spot which the laser light has irradiated on the optical disc 101, a recording pit is formed on the recording layer. The recording pit changes the reflectance of the recording layer to record data.

The laser light reflected on the recording surface of the optical disc 101 is split by the beam splitter 104, collected by the focal lens 106, and introduced to the photoelectric converter 107. The photoelectric converter 107 converts the received reflected light into an electric signal (an RF signal) and outputs the RF signal corresponding to the reflection.

The object lens 103 is controlled in inclination (tilt) in a disc radial direction (a radial tilt direction) with an actuator 160. Furthermore, the object lens 103 is moved and adjusted for laser light to focus on the surface of the optical disc. The actuator 160 may comprise a tilt coil for changing the tilt of the object lens 103 in a disc radial direction, a focus coil for shifting the object lens 103 in parallel in a direction of the rotational axis of the disc, and a tracking coil for shifting the object lens 103 in a disc radial direction (a tracking direction). A drive module 162 supplies the actuator 160 with drive current in accordance with an instruction from the system controller 114.

A temperature sensor 164 detects temperature in the optical disc device. The temperature sensor 164 may be an existing temperature sensor provided in the optical pickup 120 for detecting the temperature of the laser light source 108 or a different temperature sensor for detecting temperature around the optical disc.

The I/V converter 109 converts a current signal outputted from the photoelectric converter 107 into a voltage signal and amplifies it. The signal processor 110 is a digital signal processor (DSP), which converts the RF signal outputted from the photoelectric converter element 107 into digital data. The signal processor 110 outputs an optical-disc identifier signal differing in accordance with the type of optical disc or the disc ID for indicating the manufacturer, a focus error signal for adjusting the focal point of laser light, and a tracking error signal for following a track of the optical disc 101.

The demodulator 111 demodulates the digital data outputted from the signal processor 110 in accordance with the format specified for each type of optical disc, and performs error detection and error correction on it. The demodulated data is temporarily stored in the memory 115 (buffer).

The optical-disc identification module 112 identifies the type of the optical disc 101 loaded in the optical disc device or a disc ID for indicating the manufacturer of the optical disc 101 with reference to the optical-disc identifier signal outputted from the signal processor 110. It should be noted that the optical-disc identification module 112 may be a program to be executed by the system controller 114, although configured as a circuit module in this embodiment.

Optical disc is generally classified into CD (Compact Disc), DVD (Digital Versatile Disc), and BD (Blu-ray Disc). Furthermore, there are a plurality of types, such as -ROM (read only), -R (writable), and -RE (RW) (rewritable), in CD, DVD, and BD. To identify the type of an optical disc, various known methods can be applied. The optical-disc identifier signal may be created based on the amplitude of an RF signal, a focus error signal, or management information (BCA, Burst Cutting Area) recorded on the optical disc. In typical, a disc ID for indicating the manufacturer is recorded in an optical disc as management information, and thus a signal corresponding to the management information can be used as the optical-disc identifier signal to identify the disc ID.

The result of identification on the optical disc 101 outputted from the optical-disc identification module 112 is sent to the system controller 114 via the data bus 116. The system controller 114 controls the signal processor 110, the demodulator 111, the laser power controller 123 and the drive module 162 to be in optimum conditions (read conditions or write conditions) to the identified optical disc based on the result of identification on the optical disc.

The laser driver 113 outputs a laser drive signal for driving the laser light source 108 in the optical pickup 120. The laser power controller 123 sets a laser power target value for reading or writing in accordance with the type of the optical disc identified by the optical-disc identification module 112.

The system controller 114 comprises a microprocessor for controlling operations of the optical disc device 100 and a memory (such as a RAM and a ROM). The memory in the system controller 114 stores a program to be executed and data necessary for executing the program. The system controller 114 further comprises an interface for controlling sending and receiving of data and commands between the optical disc device 100 and the host computer 150 connected thereto. The system controller 114 controls reading of data temporarily stored in the memory 115 and writing of data to the memory 115. The system controller 114 interprets a command received from the host computer 150 and processes the received command.

The memory 115 includes a buffer area where data read from the optical disc 101 is temporarily stored. The data bus 116 connects modules in the optical disc device 100.

Next, tilt control of the object lens 103 will be explained. As shown in FIG. 2, an optical disc 101 inclines by an angle y with respect to a horizontal direction (a direction perpendicular to the rotational axis of the disc) depending on the temperature. This is because that the optical disc 101 is deformed by being warped toward the top face side or the under face side with temperature because of difference in thermal expansion rate between the top face and the under face of the optical disc 101. For example, the optical disc 101 is warped toward the under face side (or convexly warped) when the temperature is lower than a reference temperature (for example, when the temperature is 0° C.) and is warped toward the top face side (or concavely warped) when the temperature is higher than a reference temperature (for example, when the temperature is 50° C.). In such cases, for a signal corresponding to the reflection to be the maximum, it is required to tilt the object lens 103 in the disc radial direction by a tilt value (tilt angle) θ corresponding to the angle of inclination γ.

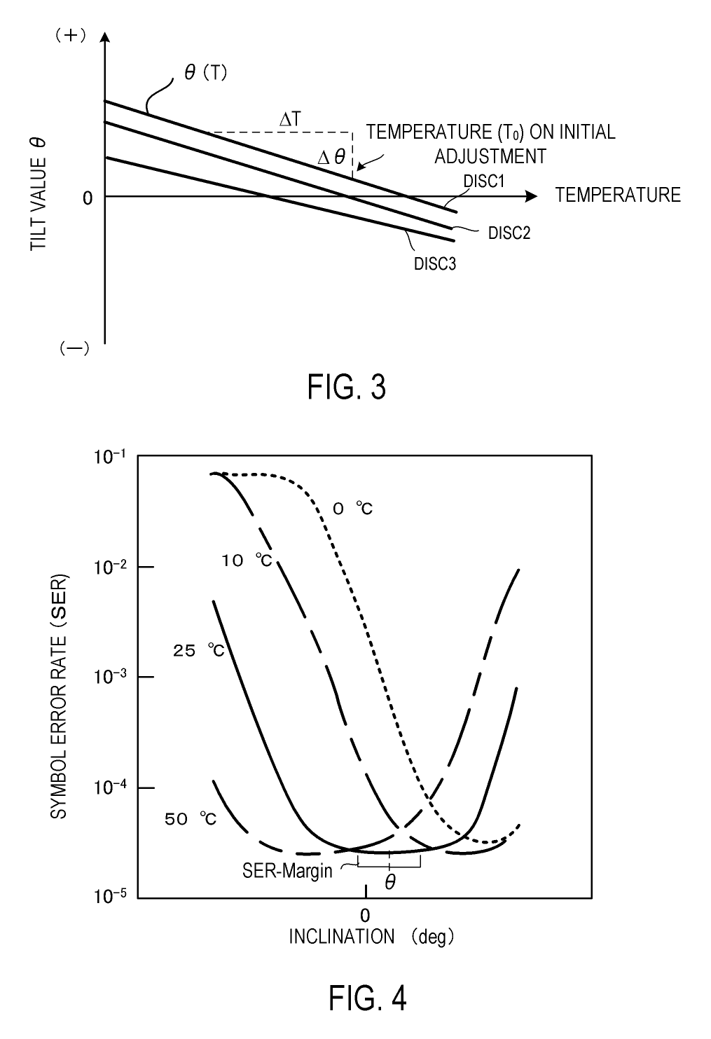

FIG. 3 shows experimentally obtained temperature dependencies of tilt values θ optimum for optical discs. A tilt value θ can be determined from the relationship between the angle of inclination of the object lens and symbol error rate (SER) obtained experimentally at each temperature as shown in FIG. 4. In FIG. 4, the symbol error rate (SER) is close to a minimum in a certain range (SER-Margin) of the angle of inclination of the object lens. The value at the center of this range is set as the tilt value θ. It should be noted that, if the minimum value of the symbol error rate is known, the angle of inclination of the object lens taking the minimum value may be selected as the tilt value θ.

The tilt value θ obtained this way is a function of the temperature T (namely, θ=θ(T)). Accordingly, even if the tilt value θ of the object lens is properly adjusted at the initial adjustment (setup) in loading an optical disc, a change in temperature ΔT after the initial adjustment requires correction of the tilt value. The correction value Δθ should be θ(T0+ΔT)−θ(T0), where T0 is the temperature at the initial adjustment. The result of experiment shows that the tilt value θ is proportional to the temperature T. In the case that the tilt value θ is proportional to the temperature T (namely, θ=αT+β), the correction value Δθ can be given by αΔT. The factor of proportionality α and the constant β depend on the type of the optical disc or the disc ID.

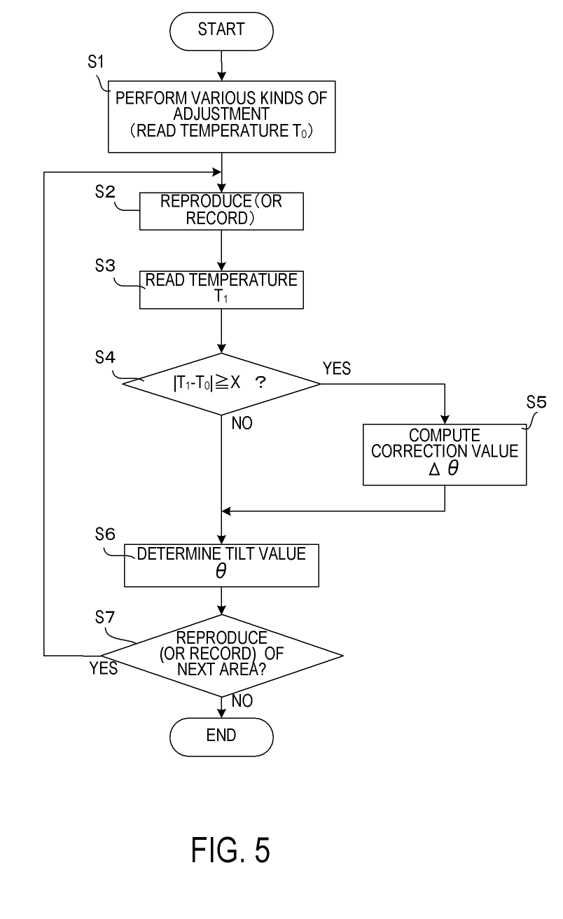

FIG. 5 is a flowchart exemplifying tilt control performed by the system controller 114. This routine starts when an optical disc is loaded. The loading of the optical disc is detected by a sensor (not shown) and a detection signal is sent to the system controller 114.

At step S1, the spindle motor 102 is rotated and the system controller 114 performs various kinds of initial adjustment of the optical disc device 100 at loading an optical disc. The initial adjustment includes identification of the type of the loaded optical disc 101 and adjustment of the optical pickup 120. The adjustment of the optical pickup 120 includes laser power adjustment, focus adjustment, and tilt adjustment at loading of an optical disc. The tilt adjustment here (initial tilt adjustment) preferably searches for the tilt value θₛ at which the amplitude of the RF signal is maximum while tilting the object lens 103 and sets the object lens 103 to tilt at the searched tilt value θₛ (standard tilt value). In addition, a temperature T0 in the optical disc device at the initial adjustment (particularly, at the tilt adjustment) is detected with the temperature sensor 164.

At step S2, the optical disc starts to be reproduced or recorded under the conditions adjusted and set at the step S1.

At step S3, the system controller 114 detects a temperature T1 in the optical disc device during reproducing or recording with the temperature sensor 164.

At step S4, the system controller 114 computes the difference in temperature ΔT (=T1−T0) between the temperature T0 at the initial adjustment in the loading of the optical disc (prior to reproducing or recording) and the temperature T1 in the optical disc device during reproducing or recording. Moreover, the system controller 114 compares the absolute value of this difference in temperature |T1−T0| with a predetermined value X to determine whether the absolute value of this difference in temperature |T1−T0| is equal to or more than the predetermined value X or not. For example, the predetermined value X is 15° C. for a BD-R.

When the absolute value of the difference in temperature is equal to or more than the predetermined value X (|T1−T0|≧X), the routine proceeds to step S5 to compute a tilt correction value Δθ. On the other hand, when the absolute value of the difference in temperature is less than the predetermined value X (|T1−T0|<X), the routine sets the tilt correction value Δθ at 0 and proceeds to step S6. In this way, when the difference in temperature between the temperature T0 at the adjustment and the temperature T1 in reproducing or recording is small, the routine does not correct the tilt value θ(Δθ=0). Consequently, the number of operations for tilt correction during reproducing or recording can be kept to the minimum necessary for stable reproducing or recording.

It should be noted that the predetermined value X may be defined as an amount of change in temperature caused by reproducing or recording operation of the optical disc device 100, for example. This amount of change in temperature is caused by laser irradiation for reproducing or recording. Under such a definition, the tilt value θ can be corrected only when the environmental temperature outside of the optical disc device has changed in addition that the temperature has changed by reproducing or recording operation of the optical disc device. Therefore, the tilt value can be corrected in response to a change in the environmental temperature around the optical disc device. The predetermined value X may be set at an amount of change in temperature which does not cause an error in reproducing or recording. The predetermined value X may be determined for each type of optical disc or each disc ID (manufacturer) and stored in the memory in the system controller 114.

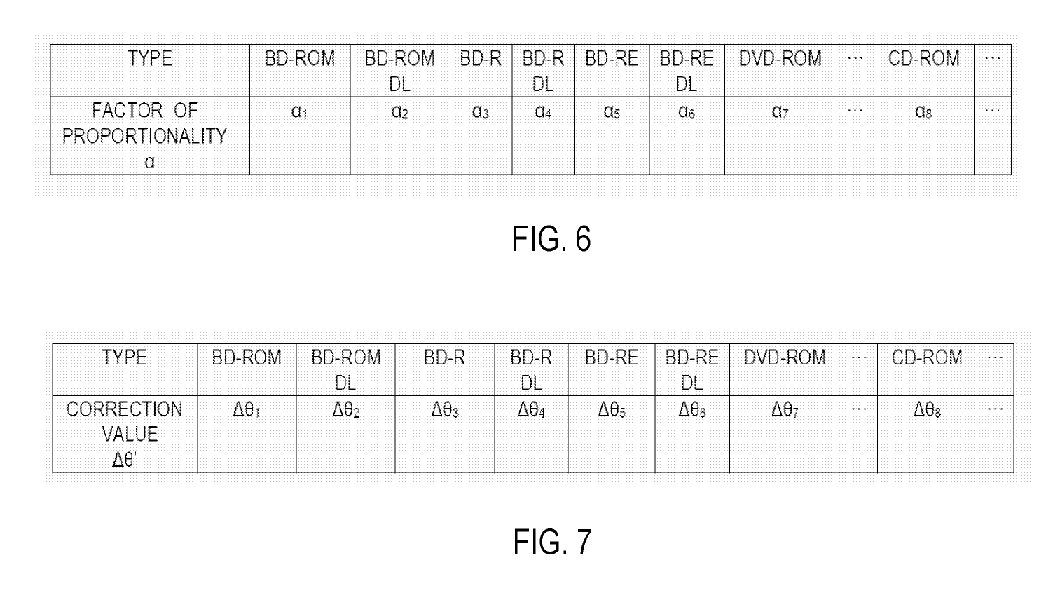

At the step S5, the system controller 114 obtains a tilt correction value Δθ. If the tilt value θ is proportional to the temperature T, the tilt correction value Δθ is a value αΔT obtained by multiplying a difference in temperature (an amount of change in temperature) Δθ by the factor of proportionality α, that is, Δθ=α×(T1−T0). The factor of proportionality α can be determined in accordance with the type of optical disc by referring to a reference table, for example, as shown in FIG. 6 which determines the factor of proportionality α for each type of optical disc, because the factor of proportionality α as an index of the correction value is dependent on the type of optical disc. The reference table is preliminarily prepared and stored in the memory in the system controller 114; it is easier and more convenient than creating by learning at the initial adjustment or during reproducing or recording.

As to the same type of optical discs, the factor of proportionality α is substantially constant regardless of the disc IDs (manufacturers). Accordingly, the tilt control in this embodiment does not calculate a correction value with the factor of proportionality α determined for each disc ID. However, the factor of proportionality α may be determined for each disc ID to calculate a correction value depending on the disc ID.

Optical discs classified into one of CD, DVD, and BD show similar tendencies in the temperature dependencies of correction values. Accordingly, one each factor of proportionality a may be determined for each of CD, DVD, and BD to calculate a correction value. An optical disc sometimes is deformed in such a manner that the cross section in its radial direction is curved, so that the degree of warping (inclination) of the optical disc changes depending on the radius R of the optical disc. In such a case, a reference table like FIG. 6 may be prepared for each radius R (or each zone) at a laser-irradiated spot of the optical disc to calculate the correction value from the factor of proportionality α for a radius R. As an example, for a BD-R, the factor of proportionality α₃ is approximately −0.01 (deg/° C.).

At step S6, the system controller 114 determines the tilt value θ at the value obtained by adding the correction value Δθ to the standard tilt value θₛ and controls the tilt of the object lens 103 in the radial direction of the optical disc at the tilt value (0=θₛ+Δθ) with the actuator 160. The system controller 114 sends an instruction signal corresponding to the tilt value θ to the drive module 162. If |T1−T0|<X, then Δθ=0, so that the tilt value should be kept at the standard tilt value θₛ.

At step S7, the system controller 114 judges whether or not the next area to be reproduced or recorded exists in the optical disc. If the next area exists, the routine returns to the step S2 to reproduce or record the next area of the optical disc. If the next area does not exist, the routine ends.

As explained above, in the first embodiment, the system controller (controller) computes a correction value depending on the change in temperature after the initial adjustment performed in loading of an optical disc and changes the tilt value in accordance with the correction value via the actuator. Through this control, the tilt value can be properly corrected for the change in temperature after the initial adjustment. Moreover, computing the correction value for each type of optical disc or disc ID achieves proper correction of the tilt value even though the optical disc is deformed by a change in temperature differently depending on the type of optical disc or disc ID. If it is configured that the tilt value is changed when a difference in temperature exceeds a predetermined value corresponding to an amount of change in temperature caused by reproducing or recording operation, the tilt value θ can be corrected only when the temperature outside the optical disc device has changed.

### Second Embodiment

In the first embodiment, it has been assumed that the tilt value θ is proportional to the temperature T to obtain the tilt correction value Δθ from the factor of proportionality α and the change in temperature ΔT using a reference table which indicates the factor of proportionality α in accordance with the type of optical disc or the like. In the second embodiment, however, the computing of the correction value is simplified. The second embodiment uses a reference table which indicates a tilt correction value (an absolute value) Δθ′ for each type of optical disc to determine the tilt correction value Δθ′ directly in accordance with the type of optical disc. This is because the tilt value θ does not actually need to be corrected precisely for the temperature and expected change in temperature is not excessively significant. The other configurations are the same as those in the first embodiment and the explanations thereof are omitted.

If the absolute value of the difference in temperature ΔT is equal to or more than the predetermined value X (|T1−T0|≧X) at step S4, the routine proceeds to step S5 to compute the tilt correction value Δθ. For example, the predetermined value X may correspond to an amount of change in temperature caused by reproducing operation or recording operation. In this case, the tilt value θ can be corrected only when the temperature outside the apparatus has changed.

At the step S5, the correction value can be obtained directly from a reference table like FIG. 7 in accordance with the type of disc. Since the reference table is preliminarily prepared and stored in the memory in the system controller 114, it is easy and convenient that there is no need to prepare the table by leaning at the initial adjustment or in reproducing or recording.

At step S6, the tilt value θ is determined and the tilt of the object lens is controlled at the determined tilt value θ with the actuator 160. If the temperature T1 inside the optical disc device becomes lower than the temperature T0 at the initial adjustment by X degrees or more (T0−T1≧X), the tilt value θ is determined at the value obtained by adding the correction value Δθ′ to the standard tilt value θₛ(θ=θₛ+Δθ′). On the other hand, if the temperature T1 inside the optical disc device becomes higher than the temperature T0 at the initial adjustment by X degrees or more (T1−T0≧X), the tilt value θ is determined at the value obtained by subtracting the correction value Δθ′ from the standard tilt value θₛ(θ=θₛ−Δθ′). These calculations correspond to computing the definitive correction values (+Δθ′, −Δθ′) depending on the change in temperature from the temperature at the initial adjustment and adding the definitive correction values to the standard tilt value θₛ. As an example, assuming that the disc is a BD-R and X=15° C., the correction value Δθ′ is approximately 0.2 (deg).

In this embodiment, it has been assumed that the optical disc 101 is warped toward the under face side (or convexly warped) when the temperature is lower than the reference temperature and is warped toward the top face side (or concavely warped) when the temperature is higher than the reference temperature. On the contrary, if the optical disc 101 is warped toward the top face side when the temperature is lower than the reference value and is warped toward the under face side when the temperature is higher than the reference value, the addition should be replaced by subtraction.

As set forth above, the second embodiment has effects of the first embodiment, and further, achieves simplification of computing the correction value since the correction value is directly determined by reference to the reference table.

While the present invention has been described in detail and pictorially in the accompanying drawings, the present invention is not limited to such detail but covers various obvious modifications and equivalent arrangements, which fall within the purview of the appended claims.

What is claimed is:

1. An optical disc device for reproducing or recording an optical disc, comprising:
an object lens configured to irradiate the optical disc with light emitted from a light source;
an actuator for controlling tilt of the object lens in a radial direction of the optical disc at a tilt value;
a temperature sensor for detecting a temperature inside the optical disc device; and
a controller for correcting the tilt value in accordance with a change in the temperature from the temperature detected at an initial adjustment of the optical disc device which is performed in loading of the optical disc.

2. The optical disc device according to claim 1, wherein the controller corrects the tilt value when the amount of the change in the temperature from the temperature detected at the initial adjustment exceeds an amount of a change in the temperature caused by reproducing or recording the optical disc.

3. The optical disc device according to claim 1, wherein the controller computes a correction value of the tilt value for each type of optical disc or disc ID.

4. The optical disc device according to claim 1, wherein the controller computes a correction value of the tilt value and sets a value obtained by adding the correction value to a standard tilt value set at the initial adjustment as a new tilt value.

5. The optical disc device according to claim 1, wherein the controller computes a correction value of the tilt value so that the correction value is proportional to the change in the temperature.

6. A recording and reproducing method used for an optical disc device for recording and reproducing an optical disc, comprising:
a first temperature detecting step of detecting a temperature inside the optical disc device at an initial adjustment performed in loading the optical disc;
a second temperature detecting step of detecting a temperature inside the optical disc device after the initial adjustment;
a controlling step of controlling tilt of an object lens in a radial direction of the optical disc at a tilt value, the object lens being configured to irradiate the optical disc with light emitted from a light source; and
a recording/reproducing step of recording or reproducing the optical disc, wherein,
at the controlling step, the tilt value is corrected in accordance with a change in the temperature from the temperature detected at the first temperature detecting step and the temperature detected at the second temperature detecting step.

7. The recording and reproducing method according to claim 6, wherein, at the controlling step, the tilt value is corrected when the amount of the change in the temperature exceeds an amount of a change in the temperature caused by recording or reproducing the optical disc.

8. The recording and reproducing method according to claim 6, wherein, at the controlling step, a correction value of the tilt value is computed for each type of optical disc or disc ID.

9. The recording and reproducing method according to claim 6, wherein, at the controlling step, a correction value of the tilt value is computed and a value obtained by adding the correction value to a standard tilt value set at the initial adjustment is set as a new tilt value.

10. The recording and reproducing method according to claim 6, wherein, at the controlling step, a correction value of the tilt value is computed so that the correction value is proportional to the change in the temperature.
